(19) United States
(12) Patent Application Publication
(10) Pub. No.: US 2007/0190930 A1
(43) Pub. Date: Aug. 16, 2007

(54) IN-CAB EDUCATIONAL SERVICES DISTRIBUTION SYSTEM

(76) Inventors: Stephen C. Fuller, Chattanooga, TN (US); Jon Michael Ricketts, Harrison, TN (US); James J. Langley, Apison, TN (US)

Correspondence Address: LUEDEKA, NEELY & GRAHAM, P.O. Box 1871, Knoxville, TN, 37901, US

(21) Appl. No.: 11/556,449

(22) Filed: Nov. 3, 2006

Related U.S. Application Data
(60) Provisional application No. 60/774,079, filed on Feb. 16, 2006.

(51) Int. Cl. H04H 7/00

(52) U.S. Cl. 455/3.06

(57) ABSTRACT

The present invention is directed to an apparatus and method for providing access to educational and training services to truck drivers in the cabs of their trucks. The apparatus includes an in-vehicle communications system that combines Wi-Fi, cellular, IP radio and satellite communications systems for sending data to and from the cab. The method includes steps of accessing educational course information from an educational institution computer system, selecting a wireless communication system for communicating with the in-vehicle communication system, transmitting the educational course information via the wireless communication system, receiving the educational course information at the in-vehicle communication system, and presenting the educational course information to an occupant of the transport vehicle using a display device associated with the in-vehicle communication system. In one embodiment, the geographic location of the transport vehicle is determined, and the wireless communication system is selected based at least in part on the geographic location.

This application claims priority to provisional patent application Ser. No. 60/774,079 filed Feb. 16, 2006 titled “In-Cab Educational Services Distribution System.”

### FIELD

This invention relates to remote learning systems. More particularly, this invention relates to distributing educational services to truck drivers via an in-cab communication system.

### BACKGROUND

Long-haul truck drivers spend most of their time on the road, either driving, resting in the truck while another driver is at the wheel or resting in the truck at a rest area or truck stop facility. Although many drivers desire to enhance their education, it has been difficult to do so because of a lack of access to educational courses during the drivers' free time. Although “distance learning” programs are offered by various colleges and universities, such programs require Internet access that has not been generally available to truck drivers in locations where drivers spend their free time, such as in rest areas and truck stops along the interstate highways.

What is needed, therefore, is a system and method for easily and reliably providing drivers access to educational services in the cabs of their trucks.

### SUMMARY

The above and other needs are met by the present invention which is directed to an apparatus and method for providing access to educational and training services for long-haul truck drivers in the cabs of their trucks. The system, referred to herein as “In-Cab University” offers a comprehensive correspondence education program specifically tailored for the truck driving population. Through a unique partnership with a traditional educational institution that offers online courses to “traditional” students, a preferred embodiment of the In-Cab University provides course offerings for GED certificates, associate degree programs and even bachelor degree programs. For example, one accredited program provides a degree in Small Business Management with a concentration in Transportation designed for the owner-operator business manager. Exemplary course offerings include accounting and finance, government regulation, basic computer skills, web-site development, geography, investing and finance, health and lifestyle, and small business management related to both trucking and non-trucking businesses. Thus, the In-Cab University offers the only education degree program specifically targeted to the truck driver population.

In a preferred embodiment, the partner traditional educational institution provides an advisor for the driver-student who helps in tracking progress and making recommendations based on the driver's previous education levels. This advisor is assigned to the driver from enrollment to graduation.

Preferably, In-Cab University is offered to drivers with the help of course sponsors. These sponsors, along with financial aid and student grants, will help absorb a significant portion of the driver's tuition costs. Also, it is anticipated that fleets will donate funding in the form of “scholarships” as a part of a retention program for drivers, much like military programs where military service is exchanged for free education. For example, in a partnership with trucking companies, In-Cab University may offer a customized curriculum that allows trucking fleets to reimburse drivers for college credit, in-exchange for a driving tenure of 2 to 4 years.

In addition to traditional coursework, In-Cab University may also provide safety and training courses that will not interfere with a driver's number one priority which is operating the truck. For example, these refresher courses may cover such topics such as backing the trailer and severe weather driving techniques.

In a preferred embodiment, In-Cab University is made available to truckers through use of a vehicle-based computer and communication system referred to herein as the In-Cab PC. The In-Cab PC is a GPS-based tracking and communication system developed by TransMarkets, LLC that operates using a combination of cellular, satellite, IP radio, and Wi-Fi communication networks for sending data to and from the cab. Use of the in-cab PC ensures that drivers can always be reached, regardless of geographical location or in the event of a natural disaster that knocks out terrestrial networks.

In addition to basic GPS and two-way communications functions, the in-cab PC includes features such as accident reconstruction with video, rear camera connectivity for safety, in-cab document scanning, route mapping, street-level directions and driver logs. The In-Cab PC also provides truck diagnostics, real-time invoicing, always-on technology and real-time updates, such as status changes updated every six minutes. Through communication with the J1708/J1939 interface and on-board computer, the In-Cab PC provides real-time equipment data and tractor diagnostics. In this way, fleets can stay connected and informed.

In a preferred embodiment, the In-Cab PC operates using a Windows XP platform and includes a rugged 8.4-inch VGA color TFT graphic LCD display, a 20 Gbyte hard-drive, 256 Mbytes of DRAM memory and an on-chip MPEG video decoder. Preferably, the unit can be operated by touch-screen or by use of a wireless keyboard/mouse.

The driver's quality of life has also been considered in the development of the In-Cab PC system. The In-Cab PC system offers a number of driver-centric features to enhance the lifestyle and work environment. The lifestyle functions include Driver in-cab email, Web-Browser VoIP Phone Service to keep in touch with family and friends, and In-Cab Navigational Mapping.

It will be appreciated that distance learning via the Internet has been available for several years. Also, in-cab computer systems for tracking and communications are well known. However, prior to the present invention there has not been a mechanism for providing educational coursework materials to truck drivers in the cabs of their trucks.

In preferred embodiments, the invention comprises a method for delivering educational services to an in-vehicle communication system disposed in a transport vehicle. The method includes (a) accessing educational course information from an educational institution computer system, (b) selecting a wireless communication system for communicating with the in-vehicle communication system, (c) transmitting the educational course information via the wireless communication system, (d) receiving the educational course information at the in-vehicle communication system, and (e) presenting the educational course information to an occupant of the transport vehicle via a display device associated with the in-vehicle communication system. In one preferred embodiment, the method also includes determining a geographic location of the transport vehicle and selecting the wireless communication system based at least in part on the geographic location of the transport vehicle. In some embodiments, the wireless communication system is selected based on the availability of communication nodes, such as WiFi, cellular, IP radio or satellite, within communication range of the transport vehicle.

### BRIEF DESCRIPTION OF THE DRAWINGS

Further advantages of the invention are apparent by reference to the detailed description in conjunction with the figure, wherein elements are not to scale so as to more clearly show the details, wherein like reference numbers indicate like elements throughout the several views, and wherein:

FIG. 1 depicts a system for distributing educational services according to a preferred embodiment of the invention.

### DETAILED DESCRIPTION

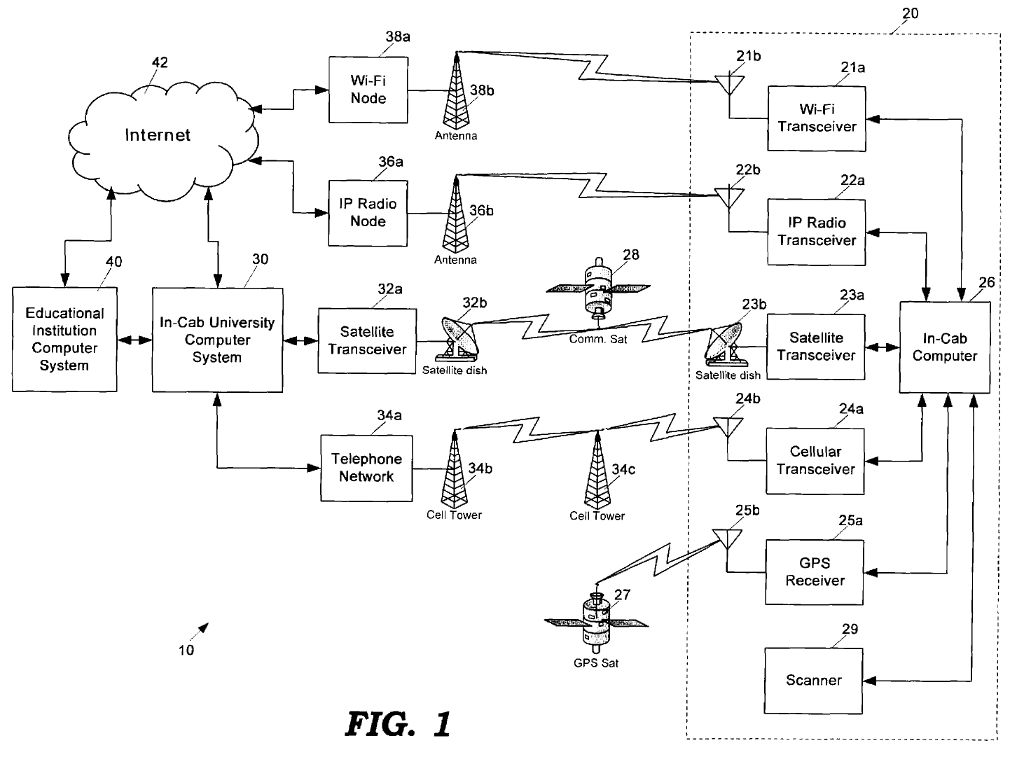

Shown in FIG. 1 is a preferred embodiment of a system 10 for providing educational services to truck drivers. The system 10 includes components installed in and on the cab of a truck (also referred to herein as the tractor portion of a tractor/trailer rig). The system 10 also includes components associated with educational services providers. Finally, the system 10 includes communications components for providing communication between the components in the cab of the truck and the educational services providers. Each of these components are discussed in further detail below.

With continued reference to FIG. 1, the system 10 includes an in-cab communication unit 20 with components installed in and on the cab of the truck. The in-cab communication unit 20 includes a Wi-Fi transceiver 21a and associated antenna 21b, an Internet Protocol (IP) radio transceiver 22a and associated antenna 22b, a satellite transceiver 23a and associated antenna 23b, a cellular transceiver 24a and associated antenna 24b, a Global Positioning System (GPS) receiver 25a and associated antenna 25b and an in-cab computer system 26. In a preferred embodiment of the invention, the in-cab communication unit 20 also includes a document scanner 29 connected to the in-cab computer 26.

The in-cab computer system 26 comprises a computer processor running an operating system such as Windows XP, a display device, such as an 8.4″ VGA color TFT graphic LCD display, a mass storage device, such as a 20 Gbyte hard-drive, a memory device, such as 256 Mbytes of DRAM memory, and user interface devices, such as a touch-screen interface and/or wireless keyboard/mouse. In the preferred embodiment, the processor includes an MPEG video decoder on-chip. The computer system 26 also includes various interface devices as are known in the art for communicating between the processor and the Wi-Fi transceiver 21a, the IP radio transceiver 22a, the satellite transceiver 23a, the cellular transceiver 24a, the GPS receiver 25a and the scanner 29.

In the preferred embodiment, the Wi-Fi transceiver 21a implements one or more radio frequency local area network (LAN) communications protocols as set forth in IEEE standard 802.11, such as 802.11b or 802.11g in the 2.4 GHz band or 802.11a in the 5 GHz band. Using the Wi-Fi transceiver 21a and a browser application running on the in-cab computer 26, the truck driver can establish a wireless LAN connection with a Wi-Fi node 38a (also referred to as a Wi-Fi “hotspot”). Such hotspots may be available in any number of places around the country on routes traveled by the truck driver, such as at truck stops located near interstate highways.

The IP radio transceiver 22a and antenna 22b provide communications between the in-cab computer 26 and an IP radio node 36a. In this manner, coursework information data may be transferred from the in-cab university computer system 30 or the educational institution computer system 40 via the Internet 42 and the IP radio node 36a to the IP radio transceiver 22a of the in-cab communication unit 20. It will be appreciated that data transfer using IP radio may be implemented in a manner similar to that of Wi-Fi systems when the transceiver 22a is in communication range of an IP radio node 36a.

The satellite transceiver 23a and antenna 23b provide communications between the in-cab computer 26 and a central satellite transceiver 32a via one or more communication satellites 28. Such satellite communications between a mobile terminal and a central ground station are known in the art. Such systems are described in U.S. Pat. Nos. 6,026,292 and 5,991,615 and the references cited therein, the disclosures of which are incorporated herein by reference.

The cellular transceiver 24a and antenna 24b provide communications between the in-cab computer 26 and a telephone communication network 34a via cellular communication units 34b and 34c. The transceiver 24a preferably implements a digital communication protocol, such as Global System for Mobile Communications (GSM) or Code-Division Multiple Access (CDMA) or Short Message Service (SMS) or combinations thereof. It will be appreciated however that the cellular transceiver 24a is not limited to any particular digital communication technology.

The GPS receiver 25a receives signals from the constellation of GPS satellites 27 and processes those signals to generate location coordinate data. The GPS receiver 25a provides the location coordinate data to the in-cab computer 26 for further processing.

As shown in FIG. 1, the system 10 includes an in-cab university computer system 30. This computer system 30 coordinates communications with the in-cab communication unit 20 to provide educational coursework information to the in-cab computer 26 using one of the available communication conduits: Wi-Fi, IP radio, satellite or cellular. The selection of the communication conduit to use at any particular time is based on several criteria, including the which conduits are available and the cost of use of the available conduits. For example, if the in-cab communication unit 20 is within communication range of both a Wi-Fi node 38a and a cellular node (34b or 34c), then the computer system 30 determines which of the available nodes is the most cost efficient for delivery of the coursework information. In most situations, the Wi-Fi node 38a will provide the most economical connection. Thus, in this example, the computer system 30 directs the coursework information to the in-cab computer 26 via the Wi-Fi node 38a. If the in-cab communication unit 20 is within communication range of a cellular node (34b or 34c) and is within the communication footprint of a communication satellite 28, the computer system 30 will direct the coursework information to the in-cab computer 26 via the cellular node, since it is typically less expensive than the satellite connection per unit time.

In some preferred embodiments of the invention, the in-cab computer 26 monitors the availability of the four communication conduits and establishes communications with the in-cab university computer system 30 via the least expensive available conduit. This decision making process may be based upon monitoring the signal strengths of signals received from each of the conduits. The decision may also be made based at least in part upon the location of the truck as determined by the location coordinates returned from the GPS receiver 25a. For example, consider a situation wherein an occupant of the vehicle other than the driver wishes to access the educational services as the truck is traveling down the highway and is at a location wherein the only communication option is satellite (expensive). Based on position coordinates, heading and speed provided by the GPS receiver 25a, the in-cab computer 26 determines that the truck will be within range of a cellular tower within five minutes. In this situation, the in-cab computer 26 will opt to not use the satellite connection in favor of the cellular connection that will be available momentarily. The in-cab computer 26 then generates a message informing the user that the connection will be delayed until the cellular option is available. In some embodiments of the invention, the user has the option of overriding the decision made by the computer 26, and manually selecting the communication conduit to be used.

The in-cab university computer system 30 also includes a database of identification information that identifies the drivers registered to participate in the in-cab university program. The database also preferably includes identification numbers assigned to the mobile communication units 20, and associates these identification numbers with the driver(s) that use the units 20. When a driver logs onto the in-cab university computer system 30 using the in-cab computer 26 via one of the communication conduits, the driver is queried for the assigned identification number(s). The computer system 30 uses the identification numbers to keep track of which courses have been completed by the driver and how much time the driver has spent logged into the system 30 to access educational course information. This information is also maintained in the database associated with the system 30. Information regarding billing, grades, and course credits is maintained on the in-cab university computer system 30.

Preferably, the coursework information is presented to the driver via a browser application or similar user interface running on the in-cab computer 26. In the preferred embodiment of the invention, no matter which communication conduit is used to receive the educational coursework information, the coursework information is presented in basically the same format for the driver.

As shown in FIG. 1, the in-cab university computer system 30 is in communication with an educational institution computer system 40, such as is maintained by a traditional educational institution. In a preferred embodiment of the invention, coursework information is developed and produced by the educational institution and is made available on the computer system 40 for access by the in-cab university computer system 30. Preferably, communication between the in-cab university computer system 30 and the educational institution computer system 40 is via a virtual private network (VPN) or other secure data transfer means.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for delivering educational services to an in-vehicle communication system disposed in a transport vehicle, the method comprising:
(a) accessing educational course information from an educational institution computer system;
(b) selecting a wireless communication system for communicating with the in-vehicle communication system;
(c) transmitting the educational course information via the wireless communication system;
(d) receiving the educational course information at the in-vehicle communication system; and
(e) presenting the educational course information to an occupant of the transport vehicle via a display device associated with the in-vehicle communication system.

2. The method of claim 1 further comprising;
(f) determining a geographic location of the transport vehicle; and
step (b) comprises selecting the wireless communication system based at least in part on the geographic location of the transport vehicle.
